(19) United States
(12) Patent Application Publication
(10) Pub. No.: US 2025/0104578 A1
(43) Pub. Date: Mar. 27, 2025

(54) Flag Stand Device

(71) Applicant: Oleg Danilov, Marion, ND (US)

(72) Inventor: Oleg Danilov, Marion, ND (US)

(21) Appl. No.: 18/808,164

(22) Filed: Aug. 19, 2024

Related U.S. Application Data
(60) Provisional application No. 63/585,339, filed on Sep. 26, 2023.

(51) Int. Cl. G09F 17/00

(52) U.S. Cl. CPC G09F 17/00; G09F 2017/0066

(57) ABSTRACT

A flag support device is disclosed for securely displaying a flag in difficult environments. The flag support device comprises a body component that is configured in a pentagonal shape and comprised of a fastener, a light, a solar panel, a battery, and an on/off button. The flag support device further comprises a receiving member designed to hold the flagpole, and a pivot point designed to attach the receiving member to the body. The flagpole can be easily inserted into the open end of the receiving member and secured in place using a fastener on the receiving member itself. The entire device can be attached to a gravesite or other surface (i.e., concrete site) using the site fastener on the bottom side of the body.

### CROSS-REFERENCE TO RELATED APPLICATION

The present application claims priority to, and the benefit of, U.S. Provisional Application No. 63/585,339, which was filed on Sep. 26, 2023, and is incorporated herein by reference in its entirety.

### FIELD OF THE INVENTION

The present invention relates generally to the field of flag-supporting devices. More specifically, the present invention relates to a flag-supporting device for display of flags at gravesites and other areas (i.e., concrete sites) where the display of a flag is desired. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in the display of flags. Generally displaying flags at gravesites, concrete sites, r other public spaces can be difficult. Because the flags are usually placed in the ground and left unattended, they typically fall over or are left in a state that is not respectful to the individual, or the flag. Further the flags can be blown completely away in storms, and damaged by lawn mowers if placed in the ground. Users need a better way to display the flags without having to return often to replace the flag or fix its position.

Further the typical flags that are used in public places such as cemeteries often have inexpensive wooden poles that break when pushed into the ground. When this happens, the flag will often touch the ground showing a sign of disrespect for many veterans. Without a way to display the flag without pushing the pole into the ground users often find themselves replacing flags more often than they would like.

Accordingly, there is a demand for a device that will display a flag properly and is resistant to many outdoor elements. More particularly there is a demand for a device that will display a flag respectfully and provide additional decorative elements to enhance the respect for a veteran.

Therefore, there exists a long-felt need in the art for a flag supporting device that provides users with an easy way to display a ceremonial flag. There is also a long felt need in the art for a flag supporting device designed with a base that can be attached to a gravestone, a concrete site, or other surface. Further there is a long felt need in the art for a flag supporting device that has an adjustable support for the flag, such that the flag can always be vertical even if the mount is on a different angle. Moreover, there is a long felt need in the art for a flag supporting device that has decorative solar powered lights for unattended display of the flag. Finally, there is a long felt need in the art for a flag supporting device that has the shape of a pentagon, referencing the military command center for veterans.

The subject matter disclosed and claimed herein, in one embodiment thereof, comprises a flag stand device. The device is a flag supporting device for displaying flags on different surfaces and angles, and capable of visual display at night. The device is comprised of a body component that is configured in a pentagonal shape and comprised of a light, a battery, a sensor, a button, and an area for attaching the receiving member. The receiving member comprises an opening to place the flagpole, a fastener to secure the flagpole, and a pivot point to allow the user to position the flag in any desired angle. Further, the base may comprise a magnet which would allow the user a place the flag supporting device onto a metal object.

In this manner, the flag supporting device of the present invention accomplishes all the forgoing objectives and provides users with a device that provides a manner to display a flag in a multitude of positions and ensuring that the flag remains intact and at the desired location. The device has battery or solar operated lights. The device can be lit up at night.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flag stand device. The device is a flag supporting device for displaying flags on different surfaces and angles, and capable of visual display at night. The flag supporting device is comprised of a body that includes a light, a battery, a sensor, a button, and an area for attaching the receiving member. The receiving member comprises an opening to place the flagpole, a fastener to secure the flagpole, and a pivot point to allow the user to position the flag in any desired angle. Further, the base may comprise a magnet which would allow the user a place the flag supporting device onto a metal object.

The present invention is directed to a flag supporting device that has particular utility in displaying flags at various positions and protecting the flag from environmental and mechanical damage. In the present invention the device can be mounted on any angled surface using its magnetic base, adhesive, or other adherence devices. Although the device may be mounted on an angle that is greater than zero, the receiving member of the device can be adjusted angularly to position the flagpole in any desired angle. Accordingly, the device has a fastener that will secure the flagpole in the receiving member, ensuring that the flag is not lost during high winds.

In one embodiment the flag support device comprises a body component that is configured in a pentagonal shape, but can be any suitable shape and size as is known in the art. The body component comprises at least one side surface, a top surface, and a bottom surface. The body can be made from solid metal, or plastic but may also be hollow. The body is also comprised of a series of lights designed to illuminate the flag support device in low light conditions. The lights are powered by a battery and controlled through a light sensor and an on/off button. The body also comprises a pivot point, located on the top surface of the body, which is further attached to the receiving member for the flagpole.

In one embodiment the flag support device comprises a body component that is configured in a pentagonal shape, but can be any suitable shape and size as is known in the art. The body further comprises a magnet or magnets attached to the bottom surface of the base to allow for magnetic attachment to metal surfaces. Alternatively, the bottom surface of the base can include an adhesive or adhesive strip for attachment to metal or other porous surfaces.

In one embodiment the flag support device comprises a body component that is configured in a pentagonal shape, but can be any suitable shape and size as is known in the art. The body is also comprised of a series of lights designed to illuminate the flag support device in low light conditions. The body further comprises a power source that is purely solar in nature and is controlled by a light sensor to determine when the device will turn on. The base further comprises a solar panel, which is designed to charge the battery for use in low light conditions.

In one embodiment the flag supporting device comprises a receiving member that is circular in the outer profile, but may be any suitable outer profile that is known in the art. The receiving member is configured as metal but may be any suitable material that is known in the art and supports the flag accordingly. The opening is cylindrical in nature but may be any suitable shape or depth that is known in the art.

In one embodiment the receiving member is attached directly to the base in a fixed position. The fixed position on the receiving member can be of any angle relative to the base that allows for proper display of the flag.

In one embodiment the lights are configured in any design or pattern on the base or receiving member. The lights could further be any color, or multiple of colors that are known in the art and provide light for the device. The lights can also be any number of lights greater than one.

In yet another embodiment the device comprises any number of decals or designed located anywhere on the device

Accordingly, the flag stand device of the present invention is particularly advantageous as it provides the user with a flag supporting device that is easily adjustable, attached, and operated. In this manner, the flag stand device overcomes the limitations of existing methods and devices used to attach decorations to gravestones and/or monuments known in the art. Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a flag stand device of the present invention in accordance with the disclosed architecture;

FIG. 2 illustrates a bottom view of one potential embodiment of a flag stand device of the present invention in accordance with the disclosed architecture;

FIG. 3 illustrates an enhanced perspective view of one potential embodiment of a flag stand device of the present invention in accordance with the disclosed architecture; and

FIG. 4 illustrates a flowchart of a method of using one potential embodiment of a flag stand device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a for a flag supporting device that provides users with an easy way to display a ceremonial flag. There is also a long felt need in the art for a flag supporting device designed with a base that can be attached to a gravestone, concrete site, or other surface. Further there is a long felt need in the art for a flag supporting device that has an adjustable support for the flag, such that the flag can always be vertical even if the mount is on a different angle. Moreover, there is a long felt need in the art for a flag supporting device that has decorative solar powered lights for unattended display of the flag. Finally, there is a long felt need in the art for a flag supporting device that has the shape of a pentagon, referencing the military command center for veterans.

The present invention, in one exemplary embodiment, is a novel flag supporting device. comprised of a flag stand device. The flag supporting device comprises a body component that is configured in a pentagonal shape and comprised of a light, a battery, a solar panel, a sensor, and a pivot point for the receiving member. The receiving member can be configured at any angle when attached to the pivot point. The light is powered by a battery through the solar panel and can be controlled through and on/off button. The present invention also includes a novel method of using the flag supporting device at a gravesite. The method includes the steps of providing a flag supporting device comprising with a body and a receiving member. The method also comprises securing the base to a grave marker via hook and loop fastener or tape. Further the method comprises positioning the receiving member in the desired location by adjusting it at the pivot point. The method also comprises placing the pole of the flag into the opening on the receiving member. Finally, the method comprises turning on the light for illumination of the flag.

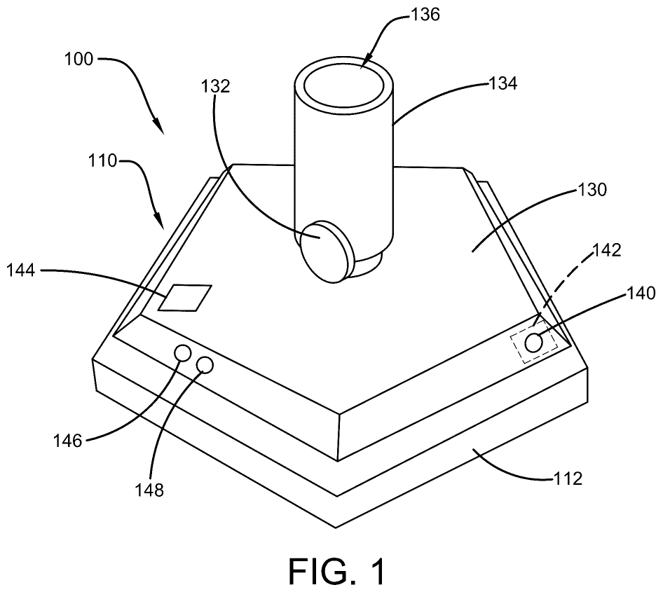

Referring initially to the drawings, FIG. 1 illustrates a perspective view of one embodiment of the flag supporting device 100 of the present invention. In the present embodiment the flag supporting device 100 is a novel flag supporting device 100 that provides the user with a device that will support a gravesite or concrete site flag securely and respectfully through any environment. Specifically, the flag supporting device 100 comprises a body 110, comprising a bottom surface 120, a top surface 130, and a side surface 112, and a pivot point 132. Further the base comprises a light 140, powered by a rechargeable battery 142, and a solar panel 144 that charges the rechargeable battery 142. The light 140 is autonomously actuated (i.e., triggered) by a sensor 148 during low light conditions, or a button 146. Furthermore FIG. 1 illustrates a perspective view of the receiving member 134, and the pivot point 132.

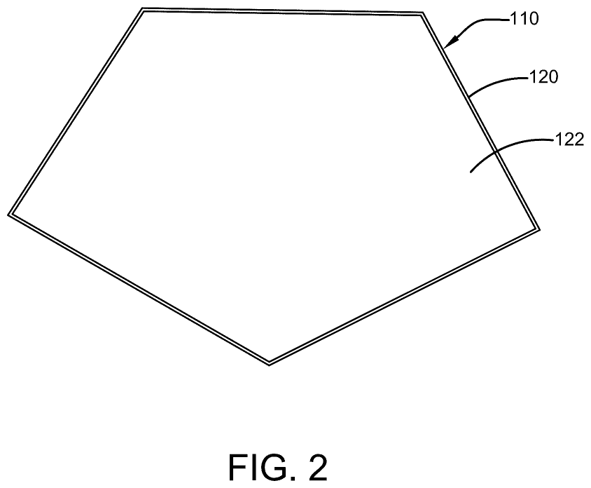

Referring initially to the drawings, FIG. 2 illustrates a bottom view of the body 100. The bottom surface 120 of the body 110 allows for the attachment of the flag supporting device 100 to the gravesite or concrete site. The body 110 comprises a bottom surface 120, and a gravesite/concrete site fastener 122. The fastener can include a magnetic fastener, a hook and loop fastener, or an adhesive strip fastener 122.

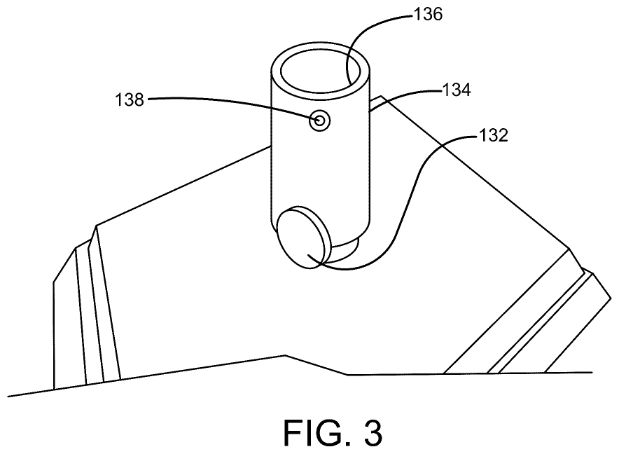

Referring initially to the drawings, FIG. 3 illustrates a perspective view of the receiving member 134. The receiving member 134 comprises an opening 136, and a flagpole fastener 138. The receiving member 134 is shown attached to the body 110 with the pivot point 132. The opening 136 in the receiving member 134 is designed to hold or secure (i.e., pin) the pole of the flag being used, and the flagpole fastener 138 is designed to threadingly move inward and outward to frictionally retain and hold the flagpole of the flag securely when inserted into the opening 136.

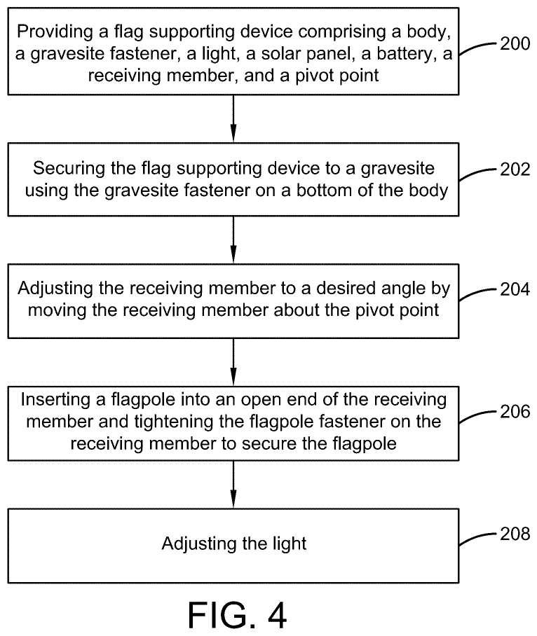

FIG. 4. Illustrates a flowchart of the method 198 of using the flag supporting device. The method includes the steps of at 200, providing a flag supporting device comprising a body with a gravesite/concrete site fastener, a light, a solar panel, and a battery, further comprising a receiving member and pivot point. The method also comprises at 202 securing the flag supporting device to a gravesite (i.e., concrete site) using the site or surface fastener 122 on the bottom surface of the body. The method also comprises at 204, adjusting the receiving member 134 to the desired angle by moving the receiving member 134 about the pivot point 132. The method further comprises at 206 inserting the flagpole into the open end of the receiving member and tightening the flagpole fastener 138 on the receiving member to secure the flagpole. Finally, the method comprises at 208 turning on (i.e., actuating) the light by pressing the button on the body.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “flag stand device” and “device” are interchangeable and refer to the flag stand device 100 of the present invention.

Notwithstanding the forgoing, the flag stand device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the flag stand device 100 as shown in the FIGS. are for illustrative purposes only, and that many other sizes and shapes of the flag stand device 100 are well within the scope of the present disclosure. Although the dimensions of the flag stand device 100 are important design parameters for user convenience, the flag stand device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A concrete site flag securing device comprising:
a flag supporting portion having a body, a base, a concrete site fastener, and a receiving portion;
a pivot point;
a flagpole fastener;
a light;
a battery; and
a solar panel;
wherein said base including said light powered by said battery;
wherein said battery charged by said solar panel;
wherein said concrete site fastener selectively fastened to a concrete site;
wherein a flagpole and flag insertable into said receiving portion;
wherein an angle of said receiving portion adjustable about said pivot point; and
further wherein said flagpole securable within said receiving portion with said flagpole fastener.

2. The concrete site flag securing device of claim 1, wherein said light selectively actuated for illuminating said flag.

3. The concrete site flag securing device of claim 1, wherein said light having a sensor for autonomously actuating said light during low light conditions.

4. The concrete site flag securing device of claim 3, wherein said concrete site fastener is a fastener between the concrete site and a bottom surface of said base selected from the group consisting of a magnetic fastener, a hook and loop fastener, and an adhesive strip fastener.

5. The concrete site flag securing device of claim 4, wherein said base having a pentagonal shape.

6. The concrete site flag securing device of claim 5, wherein said flagpole fastener insertable and retractable in said receiving portion.

7. The concrete site flag securing device of claim 6, wherein said flagpole fastener is threadingly engaged with said receiving portion.

8. A gravesite flag securing device comprising:
a flag supporting portion having a body, a base, a gravesite fastener, and a receiving portion;
a pivot point;
a flagpole fastener;
a light;
a battery; and
a solar panel;
wherein said base including said light powered by said battery;
wherein said battery charged by said solar panel;
wherein said gravesite fastener selectively fastened to a gravesite;
wherein a flagpole and flag insertable into said receiving portion;
wherein an angle of said receiving portion adjustable about said pivot point;
wherein said flagpole securable within said receiving portion with said flagpole fastener; and
further wherein said base having a pentagonal shape.

9. The gravesite flag securing device of claim 8, wherein said light selectively actuated for illuminating said flag.

10. The gravesite flag securing device of claim 8, wherein said light having a sensor for autonomously actuating said light during low light conditions.

11. The gravesite flag securing device of claim 10, wherein said concrete site fastener is a fastener between the concrete site and a bottom surface of said base selected from the group consisting of a magnetic fastener, a hook and loop fastener, and an adhesive strip fastener.

12. The gravesite flag securing device of claim 11, wherein said flagpole fastener insertable and retractable in said receiving portion.

13. The gravesite flag securing device of claim 12, wherein said flagpole fastener is threadingly engaged with said receiving portion.

14. A method of securing a flag at a concrete site, the method comprising the steps of:
providing a flag supporting portion having a body, a base, a concrete site fastener, and a receiving portion, further wherein said flag supporting portion having a pivot point, a flagpole fastener, a light, a battery, and a solar panel; and
powering said light with said battery;
charging said battery with said solar panel;
fastening said concrete site fastener to a concrete area;
inserting a flagpole into said receiving portion;
adjusting an angle of said receiving portion about said pivot point; and
securing said flagpole within said receiving portion with said flagpole fastener.

15. The method of securing a flag at a concrete site of claim 14, wherein said light selectively actuated for illuminating said flag.

16. The method of securing a flag at a concrete site of claim 14, wherein said light having a sensor for autonomously actuating said light during low light conditions.

17. The method of securing a flag at a concrete site of claim 16, wherein said concrete site fastener is a fastener between the concrete site and a bottom surface of said base selected from the group consisting of a magnetic fastener, a hook and loop fastener, and an adhesive strip fastener.

18. The method of securing a flag at a concrete site of claim 17, wherein said base having a pentagonal shape.

19. The method of securing a flag at a concrete site of claim 18, wherein said flagpole fastener insertable and retractable in said receiving portion.

20. The method of securing a flag at a concrete site of claim 19, wherein said flagpole fastener is threadingly engaged with said receiving portion.
